(19) United States
(12) Patent Application Publication
(10) Pub. No.: US 2021/0062806 A1
(43) Pub. Date: Mar. 4, 2021

(54) COMPRESSOR AND ASSEMBLING METHOD THEREOF

(71) Applicant: SHANGHAI HIGHLY ELECTRICAL APPLIANCES CO., LTD., Shanghai (CN)

(72) Inventors: Bo HUANG, Shanghai (CN); Fengrong ZHAO, Shanghai (CN); Yiqun TANG, Shanghai (CN)

(73) Assignee: SHANGHAI HIGHLY ELECTRICAL APPLIANCES CO., LTD., Shanghai (CN)

(21) Appl. No.: 16/644,780

(22) PCT Filed: Feb. 12, 2018
(86) PCT No.: PCT/CN2018/076424

§ 371 Date: Mar. 5, 2020

(30) Foreign Application Priority Data
Sep. 6, 2017 (CN) 201710797161.1

(51) Int. Cl. F04B 53/16; F04B 9/02; F04B 53/00; F04B 53/14; B23K 26/21

(52) U.S. Cl. CPC F04B 53/16; F04B 9/02; B23K 2101/04; F04B 53/14; B23K 26/21; F04B 53/006

(57) ABSTRACT

A compressor comprises a housing; a motor and a cylinder in the housing; a crankshaft for transmitting rotation force of the motor to pistons of the cylinder for compressing refrigerant; a compressing space formed by an upper cylinder cover, a lower cylinder and the cylinder and the upper cylinder cover and the lower cylinder cover are also used to prop up the crankshaft. The upper cylinder cover is disposed between the motor and the cylinder. The upper cylinder cover includes an through-hole for holding the crankshaft. The upper cylinder cover includes a first side facing the motor and a second side facing the cylinder. An inner wall of the casing is laser welded with an outer periphery of the first side and/or an outer periphery of the second side of the upper cylinder cover.

### CROSS-REFERENCE TO RELATED APPLICATIONS

This application is a continuing application of International Application No. PCT/CN2018/076424, filed on Feb. 12, 2018, which is based upon and claims priority to Chinese Patent Application 201710797161.1, filed on Sep. 6, 2017, the entire contents of which are incorporated herein by reference.

### TECHNICAL FIELD

The present disclosure generally relates to refrigeration field, and more particularly, to rolling rotor compressor and assembling method thereof.

### BACKGROUND

In general, a hermetic compressor includes a motor, in an internal space of a sealed housing, for generating a driving force, and a compression member coupled to the motor for compressing refrigerant.

Hermetic compressors are classified, according to the compression mechanism for refrigerant, into different types including reciprocating compressors, scroll compressors, and rolling-rotor compressors. Reciprocating compressors, scroll compressors, and rolling-rotor compressors all use the rotational force of a motor.

In assembling most of the existing rolling-rotor compressors, the pump is firstly assembled (mainly including: crankshaft, piston, cylinder, upper and lower cylinder heads, blades, etc.), after the parts are processed. The pump is welded with the housing by three points/six points welding process.

However, this assembling method will cause welding deformation to affecting assembly accuracy and the air gap of the stator and rotor will be uneven which results in noise increments and poor performance.

Therefore, the present disclosure discloses a compressor and an assembling method thereof.

### SUMMARY

In view of the problems in the existing technology, the purpose of the present disclosure is to provide a compressor and an assembling method thereof, which will reduce deformation, caused by welding, to affecting assembly accuracy and ensure the air gap of the stator and rotor is even for reducing the noise and improving performance.

In one embodiment of the present disclosure, a compressor comprises a housing, a motor and a cylinder disposed in the housing, a crankshaft which is used to transmit rotation force of the motor to pistons of the cylinder for compressing refrigerant. An upper cylinder cover, a lower cylinder cover and the cylinder form a compressing space. The upper cylinder cover and the lower cylinder cover are also used to prop up the crank shaft. The upper cylinder cover is disposed between the motor and the cylinder and the upper cylinder cover including an through-hole used for holding the crankshaft.

The upper cylinder cover includes a first side facing the motor and a second side facing the cylinder. An inner wall of the housing is laser welded with an outer periphery of the first side and/or an outer periphery of the second side of the upper cylinder cover. An angle between an axis of each of welding spots and the inner wall of the housing is in a range of 0° to 45°.

In one embodiment of the present disclosure, a method of assembling a compressor, wherein, the method comprises steps of providing a housing and an upper cylinder cover and welding, by a laser transmitter, an inner wall of the housing with an outer periphery of a first side of the upper cylinder cover and/or an outer periphery of a second side of the upper cylinder cover. An angle between an axis of the laser transmitter and the inner wall of the housing is in a range of 0° to 45°.

It is to be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a cross-sectional view of a compressor of the present disclosure;

FIG. 2 is a schematic view of welding of an upper cylinder cover and an inner wall of a housing in a compressor of a first embodiment of the present disclosure;

FIG. 3 is an enlarged view of M region of FIG. 2;

FIG. 4 is a schematic view of FIG. 2 along an A direction;

FIG. 5 is a schematic view of FIG. 2 along a B direction;

FIG. 6 is a schematic view of welding of an upper cylinder cover and an inner wall of a housing in a compressor of a second embodiment of the present disclosure;

FIG. 7 is a schematic view of FIG. 6 along a C direction;

FIG. 8 is a schematic view of welding of an upper cylinder cover and an inner wall of a housing in a compressor of a third embodiment of the present disclosure; and

FIG. 9 is a schematic view of FIG. 8 along a D direction.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

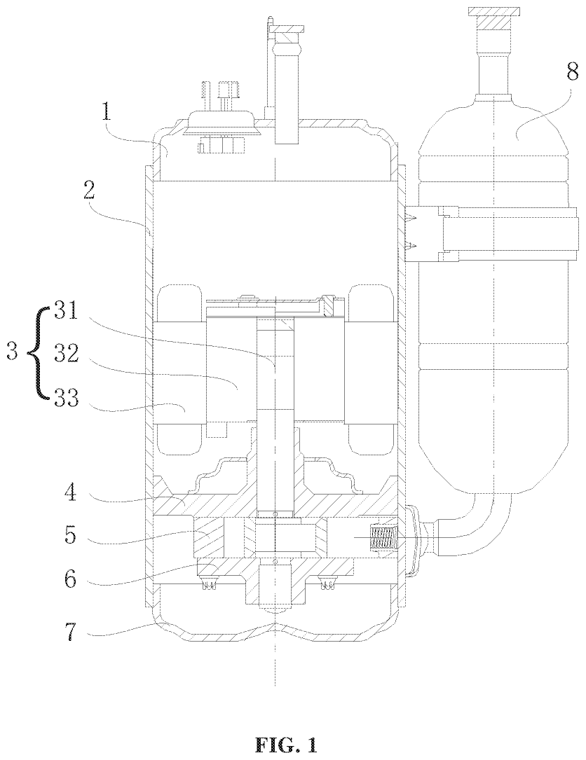

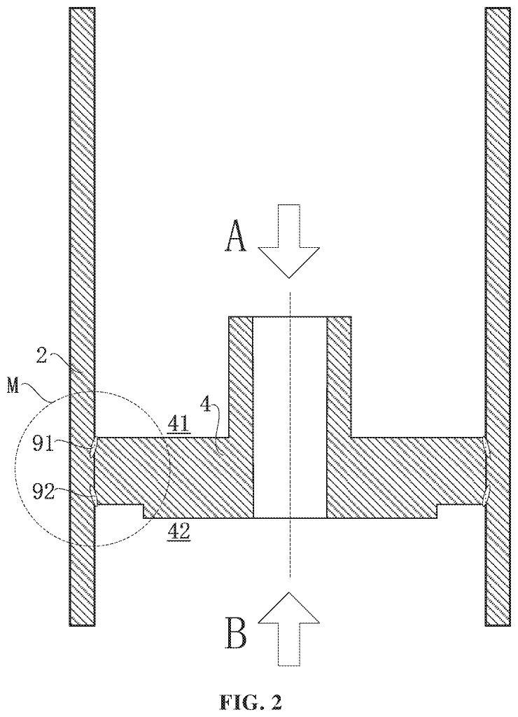

FIG. 1 is a cross-sectional view of a compressor of the present disclosure. FIG. 2 is a schematic view of welding of an upper cylinder cover and an inner wall of a housing in a compressor of a first embodiment of the present disclosure. As shown in FIGS. 1 and 2, the compressor of the present disclosure includes a cover 1, a housing 2, a motor 3, an upper cylinder cover 4, a cylinder 5, a lower cylinder cover 6, a lower cover 7 and a liquid container 8. The motor 3 and the cylinder 5 are disposed in the housing 2. The motor 3 includes an inner rotor 32 and an outer stator 33. A crankshaft 31 is used to transmit rotation force of the motor 3 to pistons of the cylinder 5 for compressing refrigerant. A compressing space is formed by an upper cylinder cover 4, a lower cylinder 6 and the cylinder 5. The upper cylinder cover and the lower cylinder cover are also used to prop up the crankshaft 31. The upper cylinder cover 4 is located between the motor 3 and the cylinder 5.

The upper cove 1 and the lower cover 7 are respectively cover two ends of the housing 2. The liquid container 8 is connected to the cylinder 5 to provide refrigerant to the cylinder 5. The upper cylinder cover 4 includes a through-hole for used for holding the crankshaft 31. The upper cylinder cover 4 includes a first side 41 facing the motor 3 and a second side 42 facing the cylinder 5. An inner wall of the housing 2 is laser welded with an outer periphery of the first side 41 and an outer periphery of the second side 42 of the upper cylinder cover 4. An angle between an axis of each of welding spots and the inner wall of the housing 2 is in a range of 0° to 45°.

The material of the upper cylinder cover 4 includes gray iron and the material of the housing 2 includes carbon steel. The upper cylinder, including gray iron material, is laser welded, along two directions, with the housing, including carbon steel material. A welding depth of the present disclosure indicates a distance between the deepest position of the melting part of the base metal and the surface of the base metal.

In one embodiment of the present disclosure, an angle between the axis of the welding spot and the housing 2 is in a range of 15° to 30°.

In one embodiment of the present disclosure, the outer periphery of the first side 41 and the outer periphery of the second side 42 of the upper cylinder cover 4 are respectively laser welded, with the inner wall of the housing 2. In some embodiments, the outer periphery is fully welded with the inner wall of the housing 2. In some embodiments, the outer periphery is welded with the inner wall of the housing 2 with two weld seam or a plurality of weld seam. The weld seam are distributed on the outer periphery.

In some embodiments, the weld seam are asymmetrically distributed on the outer periphery.

In some embodiments, the welding depth of the welding spot is greater than 1.5 mm but is not limited herein. When the welding depth of the welding spot is greater than 1.5 mm, the requirements of strength and rigidity are then meet. Therefore, the more the depth is, the better the rigidity of the connector is.

In some embodiments, the outer periphery of the first side 41 and the outer periphery of the second side 42 of the upper cylinder cover 4 are respectively laser welded, by multi-point distributed laser welding, with the inner wall of the housing 2. The welding depth, in this embodiment, of the welding spot between the outer periphery of the first side 41 of the upper cylinder cover 4 and the inner wall of the housing 2 is equal to the welding spot between the outer periphery of the second side 42 of the upper cylinder cover 4 and the inner wall of the housing 2. Under the premise of the equal welding depth, the effect is the best when two sides, upper side and lower side, are welding all. The connection strength between the upper cylinder cover 4 and the inner wall of the housing 2 is then ensured.

The outer periphery of the upper cylinder cover 4 is slight interference fit with the inner wall of the housing 2 or the outer periphery of the upper cylinder cover 4 is clearance fit with the inner wall of the housing 2. A unilateral side of the slight interference fit is smaller than 0.5 mm and wherein a unilateral side of the clearance fit is greater than −0.5 mm but is not limited herein. The welding spots are axis symmetrically distributed on the outer periphery of the upper cylinder cover 4 but is not limited herein.

In some embodiments, the chamfered side of the end face of the upper cylinder cover is smaller than 0.5 mm.

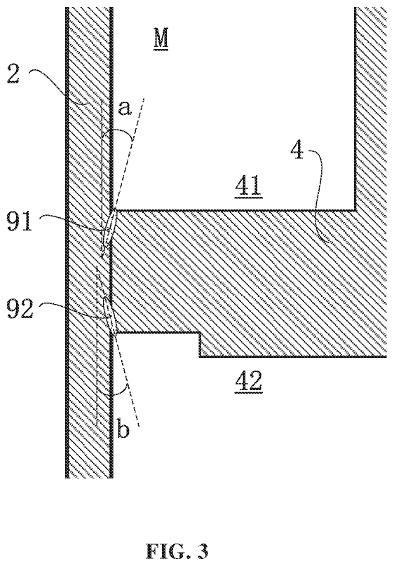

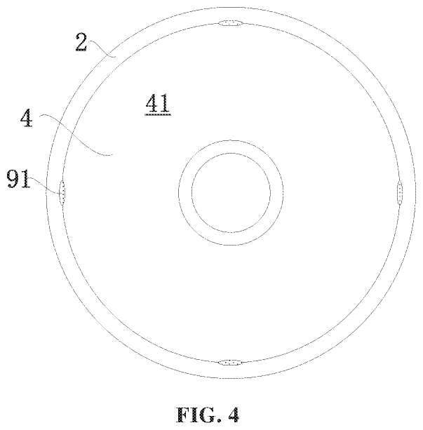

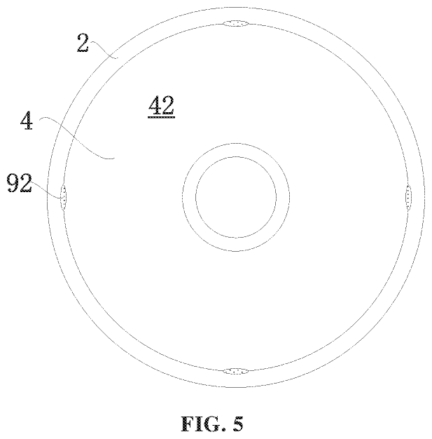

FIG. 3 is an enlarged view of M region of FIG. 2. FIG. 4 is a schematic view of FIG. 2 along an A direction. FIG. 5 is a schematic view of FIG. 2 along a B direction. As shown in FIGS. 2 to 5, in this embodiment, a plurality of welded spots 91 are formed, by laser welding, between the outer periphery of the first side 41 of the upper cylinder 4 and the inner wall of the housing 2. An angle a is formed between the welding spot 91 and the inner wall. The angle a is in a range of 0° to 45°. In some embodiments, the angle a is in a range of 15° to 30°. Similarly, a plurality of welded spots 92 are formed, by laser welding, between the outer periphery of the second side 42 of the upper cylinder 4 and the inner wall of the housing 2. An angle b is formed between the welding spot 91 and the inner wall. The angle b is in a range of 0° to 45°. In some embodiments, the angle b is in a range of 15 to 30°.

As shown in FIGS. 1 to 5, the present disclosure further discloses a method of assembling a compressor. In this embodiment, a housing and an upper cylinder cover are provided. An inner wall of the housing is welded, by a laser transmitter, with an outer periphery of a first side of the upper cylinder cover and/or an outer periphery of a second side of the upper cylinder cover. An angle between an axis of the laser transmitter and the inner wall of the housing is in a range of 0° to 45°.

After the upper cylinder cover and the housing are welded, a connector is then fine finished. The deformation caused by welding is reduced and the assembling accuracy is then improved. Therefore, the air gap of the stator and rotor is even for reducing the noise and improving performance. The assembling method further includes other regular assembling steps, e.g. pump assembling, mainly including crankshaft, piston, cylinder, upper and lower cylinder covers, vanes, and will not repeated herein.

In one embodiment of the present disclosure, an angle between the axis of the laser transmitter and the housing 2 is in a range of 15° to 30°.

In one embodiment of the present disclosure, the welding depth of the welding spot is greater than 1.5 mm.

In one embodiment of the present disclosure, the outer periphery of the first side and the outer periphery of the second side of the upper cylinder cover are respectively laser welded by two laser transmitters, by multi-point distributed laser welding, with the inner wall of the housing. The welding depth, in this embodiment, of the welding spot of the outer periphery of the first side of the upper cylinder cover and the inner wall of the housing is equal to the welding spot of the outer periphery of the second side of the upper cylinder cover and the inner wall of the housing.

In one embodiment of the present disclosure, the material of the upper cylinder cover includes gray iron and the material of the housing includes carbon steel. During the welding process, since gray iron includes a higher carbon content than carbon steel, the power of the laser welding is mainly applied on the housing who includes carbon steel with lower carbon content. An angle between an axis of the laser transmitter and the inner wall of the housing is in a range of 0° to 45°.

In one embodiment of the present disclosure, the outer periphery of the upper cylinder cover is slight interference fit with the inner wall of the housing or the outer periphery of the upper cylinder cover is clearance fit with the inner wall of the housing. A unilateral side of the slight interference fit is smaller than 0.5 mm and wherein a unilateral side of the clearance fit is greater than −0.5 mm.

In one embodiment of the present disclosure, the welding spots are axis symmetrically distributed on the outer periphery of the upper cylinder cover.

In one embodiment of the present disclosure, the welding spots are asymmetrically distributed on the outer periphery.

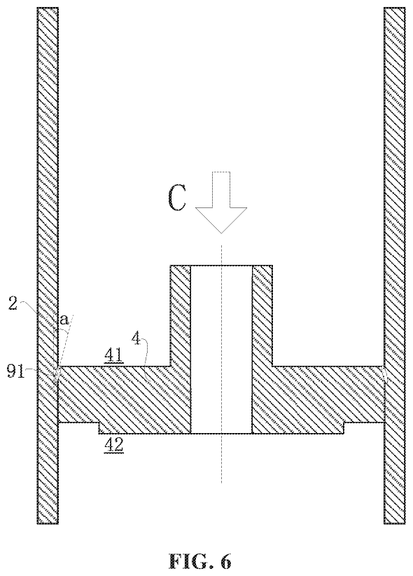

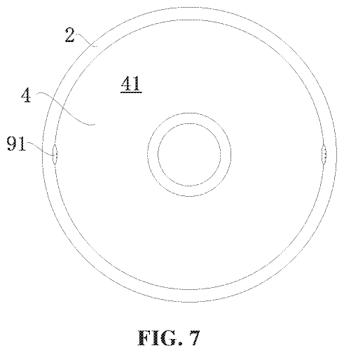

FIG. 6 is a schematic view of welding of an upper cylinder cover and an inner wall of a housing in a compressor of a second embodiment of the present disclosure. FIG. 7 is a schematic view of FIG. 6 along a C direction. As shown in FIGS. 6 and 7, the second embodiment of the present disclosure is a modification of the first embodiment. The inner wall of the housing 2 of the second embodiment is welded, two welding spots, with the outer periphery of the first side 41 of the upper cylinder cover 4. The welding spots 91 are axis symmetrically distributed on the outer periphery of the upper cylinder cover. An angle a of the axis of the welding spot 91 and the inner wall of the housing 2 is in a range of 0° to 45°. The second side 42 of the upper cylinder 4 is not necessary to be welded with the inner wall of the housing 2. In the second embodiment, the laser transmitter is not needed which will reduce the assembling cost and time.

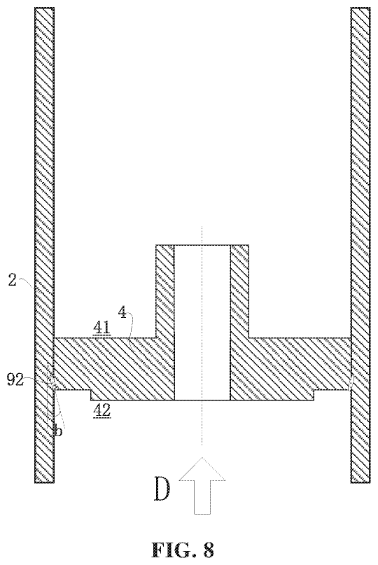

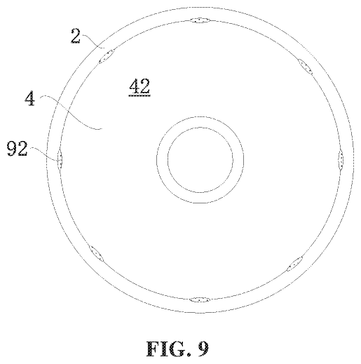

FIG. 8 is a schematic view of welding of an upper cylinder cover and an inner wall of a housing in a compressor of a third embodiment of the present disclosure. FIG. 9 is a schematic view of FIG. 8 along a D direction. As shown in FIGS. 8 and 9, the third embodiment of the present disclosure is a modification of the first embodiment. The inner wall of the housing 2 of the third embodiment is welded, a plurality of welding spots, with the outer periphery of the second side 42 of the upper cylinder cover 4. An angle b of the axis of the welding spot 92 and the inner wall of the housing 2 is in a range of 0° to 45°. The first side 41 of the upper cylinder 4 is not necessary to be welded with the inner wall of the housing 2. In the third embodiment, the laser transmitter is not needed which will reduce the assembling cost and time.

In conclusion, the compressor and the method of assembling thereof will improve the assembling accuracy without deformation caused by welding. Therefore, the air gap of the stator and rotor is even for reducing the noise and improving performance.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A compressor, comprising:
a housing;
a motor and a cylinder disposed in the housing;
a crankshaft used to transmit rotation force of the motor to pistons of the cylinder for compressing refrigerant;
a compressing space formed by an upper cylinder cover, a lower cylinder and the cylinder and the upper cylinder cover and the lower cylinder cover are also used to prop up the crank shaft;
wherein the upper cylinder cover is disposed between the motor and the cylinder and the upper cylinder cover including an through-hole used for holding the crankshaft;
wherein the upper cylinder cover includes a first side facing the motor and a second side facing the cylinder;
wherein an inner wall of the housing is laser welded with an outer periphery of the first side and/or an outer periphery of the second side of the upper cylinder cover; and
wherein an angle between an axis of each of welding spots and the inner wall of the housing is in a range of 0° to 45°.

2. The compressor of claim 1, wherein an angle between the axis of the welding spot and the housing is in a range of 15° to 30°.

3. The compressor of claim 1, wherein a welding depth of the welding spot is greater than 1.5 mm.

4. The compressor of claim 1, wherein the outer periphery of the first side and the outer periphery of the second side of the upper cylinder cover are respectively laser welded, by multi-point distributed laser welding, with the inner wall of the housing;
wherein a welding depth of a welding spot of the outer periphery of the first side of the upper cylinder cover and the inner wall of the housing is equal to a welding spot of the outer periphery of the second side of the upper cylinder cover and the inner wall of the housing.

5. The compressor of claim 1, wherein the material of the upper cylinder cover includes gray iron and the material of the housing includes carbon steel.

6. The compressor of claim 1, wherein the outer periphery of the upper cylinder cover is slight interference fit with the inner wall of the housing or the outer periphery of the upper cylinder cover is clearance fit with the inner wall of the housing;
wherein a unilateral side of the slight interference it is smaller than 0.5 mm and wherein a unilateral side of the clearance fit is greater than −0.5 mm.

7. The compressor of claim 1, wherein the welding spots are axis symmetrically distributed on the outer periphery of the upper cylinder cover.

8. A method of assembling a compressor, the method comprising steps of:
providing a housing and an upper cylinder cover,
welding, by a laser transmitter, an inner wall of the housing with an outer periphery of a first side of the upper cylinder cover and/or an outer periphery of a second side of the upper cylinder cover;
wherein an angle between an axis of the laser transmitter and the inner wall of the housing is in a range of 0° to 45°.

9. The method of claim 8, wherein an angle between an axis of the laser transmitter and the housing is in a range of 15° to 30° and a welding depth of the welding spot is greater than 1.5 mm.

10. The method of claim 8, wherein the outer periphery of the first side and the outer periphery of the second side of the upper cylinder cover are respectively laser welded by two laser transmitters, by multi-point distributed laser welding, with the inner wall of the housing;
wherein a welding depth of a welding spot of the outer periphery of the first side of the upper cylinder cover and the inner wall of the housing is equal to a welding spot of the outer periphery of the second side of the upper cylinder cover and the inner wall of the housing.
